(19) United States
(12) Patent Application Publication
(10) Pub. No.: US 2026/0018823 A1
(43) Pub. Date: Jan. 15, 2026

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: GUI-LONG CHENG, Shenzhen (CN); TENG HUANG, Shenzhen (CN); DE-JIN CHEN, Shenzhen (CN)

(21) Appl. No.: 19/263,984

(22) Filed: Jul. 9, 2025

(30) Foreign Application Priority Data
Jul. 9, 2024 (CN) 202410912948.8

(51) Int. Cl. H01R 13/504; H01R 13/02; H01R 13/426; H01R 103/00

(52) U.S. Cl. CPC H01R 13/504; H01R 13/025; H01R 13/426; H01R 2103/00; H01R 2201/26

(57) ABSTRACT

An angled cable connector includes: a wire cable component having an inner conductor, an outer conductor, and a cable electrically connected with the inner conductor; a first outer housing; and a second outer housing; the first outer housing and the second outer housing cooperate with each other and form a complete outer housing to receive the wire cable component; the first outer housing has a lower end face facing downward and a rear end face facing rearward, and the second outer housing comprises a hollow barrel portion through which the cable passes and a rear cover extending upward from a rear part of the barrel portion, the barrel portion abutting the lower end face and the rear cover forwardly abutting the rear end face in a front and rear direction; and a mating edge of the first outer housing and the second outer housing is L-shaped.

### BACKGROUND OF THE INVENTION

### Field of the Invention

The present invention relates to an angled electrical connector.

### Description of Related Arts

China Patent No. 217281302U discloses a terminal assembly and an electrical connector comprising same. The terminal assembly comprises an L-shaped insulating housing, a terminal fixed in the insulating housing and an L-shaped shielding shell fixed outside the insulating housing. The insulating housing has a first insulating portion extending along a first direction and a second insulating portion extending along a second direction perpendicular to the first direction. The shielding shell has plural shielding portions and at least one of the shielding portions is made by stamping, and thus the shielding shell is easy to make. It is beneficial for reducing a production cost and minimizing the size of the electrical connector. However, the connector is not strong enough when used in many applications, e.g., automotive applications or industrial applications. Therefore, it is desired to provide an improved electrical connector.

### SUMMARY OF THE INVENTION

An object of the present invention is to provide an improved electrical connector.

To achieve the above object, an angled cable connector comprises: a wire cable component comprising an inner conductor, an outer conductor, and a cable electrically connected with the inner conductor; a first outer housing; and a second outer housing; wherein the first outer housing and the second outer housing cooperate with each other and form a complete outer housing to receive the wire cable component; the first outer housing has a lower end face facing downward and a rear end face facing rearward, and the second outer housing comprises a hollow barrel portion through which the cable passes and a rear cover extending upward from a rear part of the barrel portion, the barrel portion upwardly abutting the lower end face of the first outer housing and the rear cover forwardly abutting the rear end face of the first outer housing in a front and rear direction; and a mating edge of the first outer housing and the second outer housing is L-shaped.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an angled connector;

FIG. 2 is another perspective view of the angled connector;

FIG. 3 is a cross-sectional view of the angled connector taken along line A-A in FIG. 2;

FIG. 4 is a cross-sectional view of the angled connector taken along line B-B in FIG. 2;

FIG. 5 is an exploded perspective view of the angled connector;

FIG. 6 is another exploded perspective view of the angled connector in FIG. 5;

FIG. 7 is a perspective view of the angled connector when a wire cable component is assembled into a first outer housing and a second outer housing is removed;

FIG. 8 is an exploded perspective view of the wire cable component in FIG. 7; and

FIG. 9 is another exploded perspective view of the wire cable component of FIG. 8.

### DETAILED DESCRIPTION OF THE PREFERRED EMBODIMENT

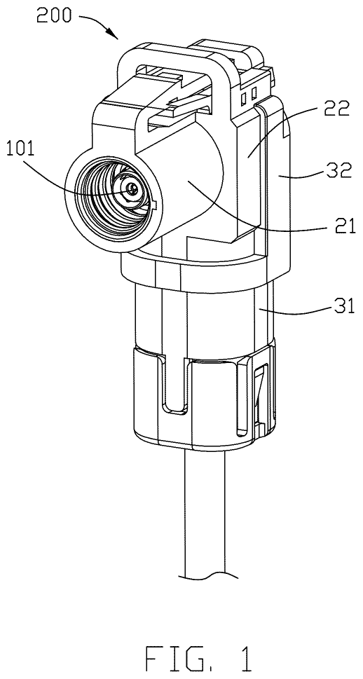

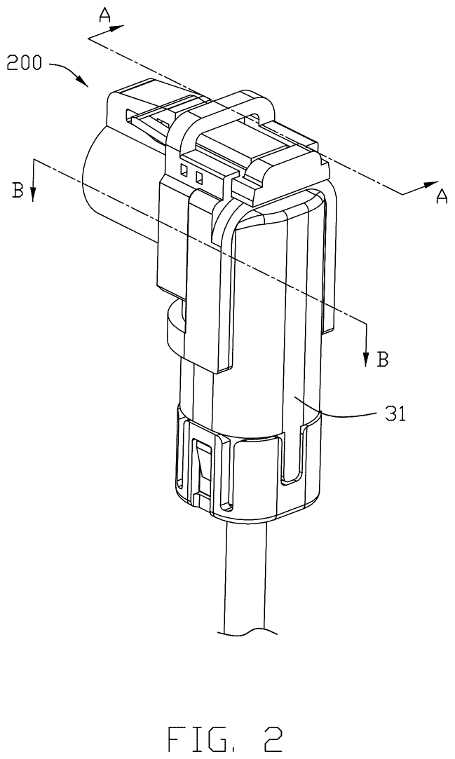

Referring to FIGS. 1-7, an angled connector 200 used in a vehicle is illustrated. In some embodiments, the angled connector 200 is a waterproof cable connector which includes a wire cable component 10, a first outer housing 20, a second outer housing 30, a front seal 42 and a lower seal 43.

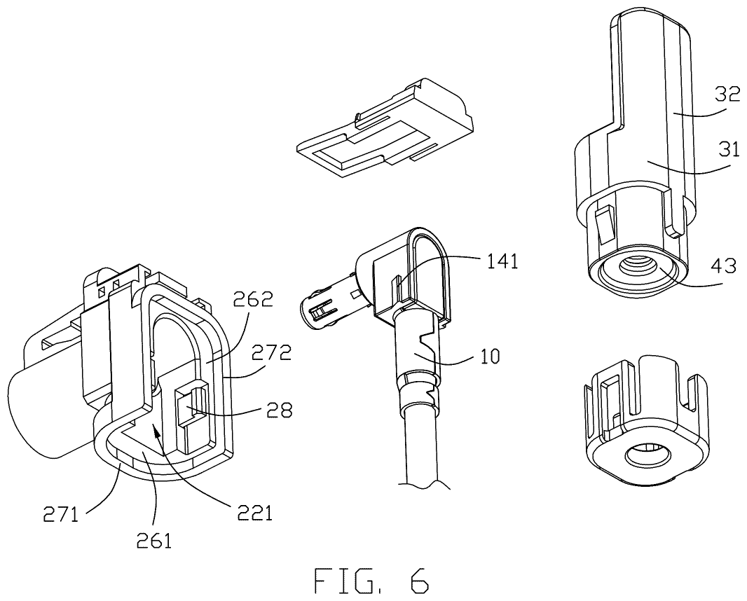

Referring to FIGS. 6, and 8-9, the wire cable component 10 includes an outer conductor 11, an inner conductor 13 and a cable 15 connected to the inner conductor 13. The inner conductor 13 is received and retained in an inner insulating housing 12. Combining with FIGS. 1, and 3-6, an inserting socket 101 comprises the inner conductor 13, the outer conductor 11 and the inner insulating housing 12 therebetween. The cable 15 extends downward from the inner conductor 13. Thus, the cable 15 together with the inserting socket 101 form an L shape. Namely, the wire cable component 10 is L-shaped. The first outer housing 20 sleeves the inserting socket 101 and the second outer housing 30 sleeves the cable 15. The first outer housing 20 and the second outer housing 30 form a complete housing. For a clearer and more convenient description, a forward direction is defined as an inserting direction of the angled connector 200 and a downward direction is a direction where the cable 15 extends.

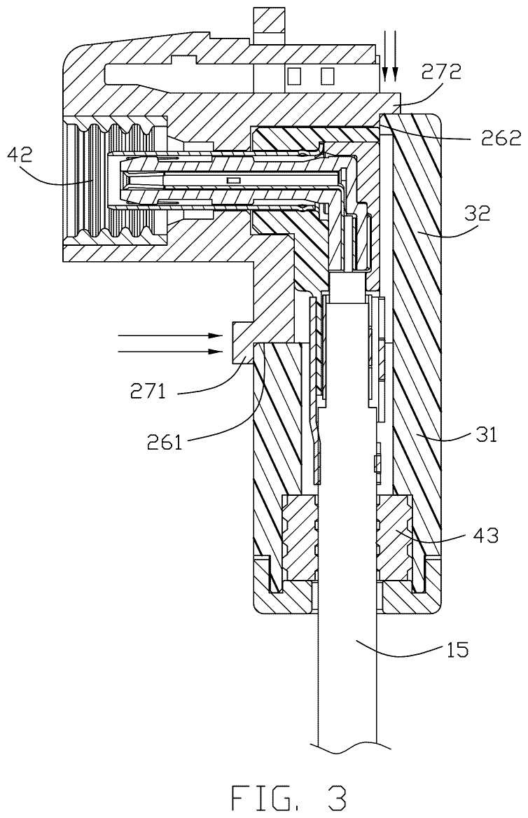

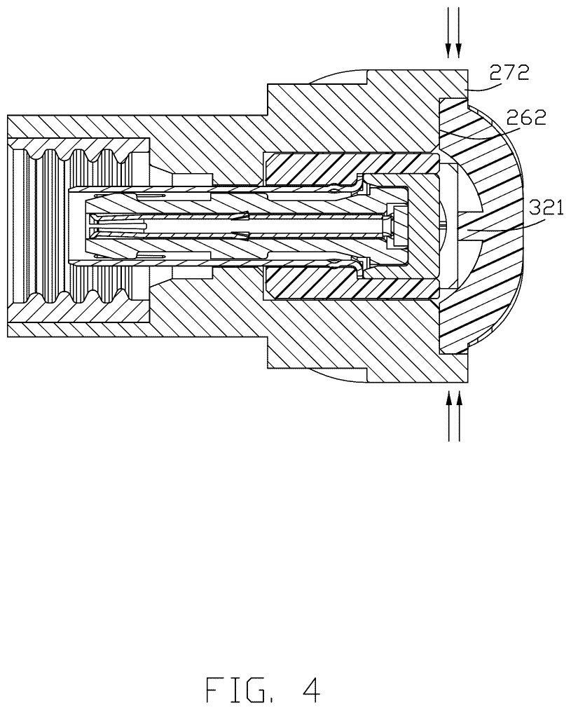

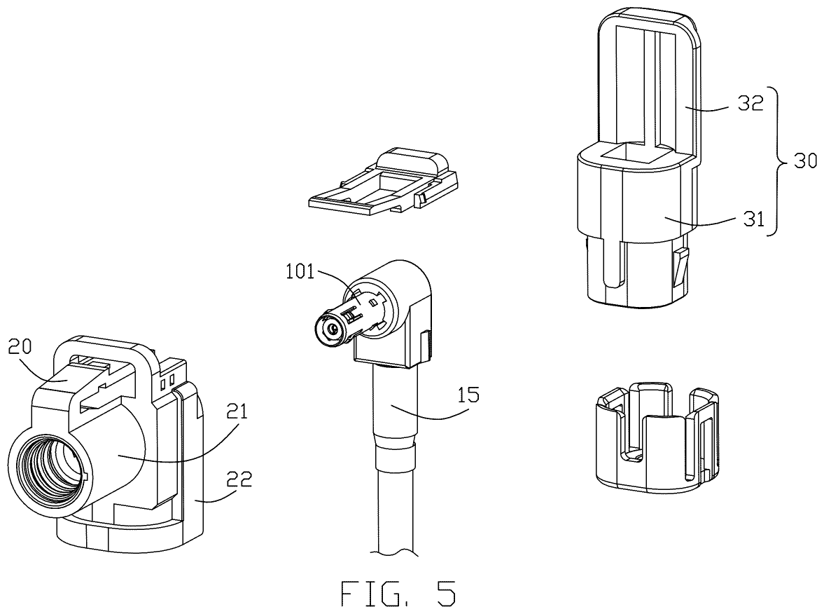

Referring to FIGS. 5-6, the first outer housing 20 and the second outer housing 30 are injection molded independently and can be assembled together to cooperate with each other along a horizontal direction. The first outer housing 20 comprises a base portion 22 and a mating portion 21 extending from the base portion 22. The first housing has a lower end face 261 facing downward and a rear end face 262 facing rearward. The lower end face 261 and the rear end face 262 are angled with each other. The second outer housing 30 comprises a hollow barrel portion 31 and a rear cover 32 extending upward from a rear part of the barrel portion 31. The cable 15 of the wire cable component 10 connected with the inserting socket 101 passes through the barrel portion 31 downwardly first and then is assembled forward to the first outer housing 20 together with the second outer housing 30. Combining with FIG. 3, an upper end face of the barrel portion 31 cooperates with the lower end face 261 and a front face of the rear cover 32 cooperates with the rear end face 262 to make the first outer housing 20 and the second outer housing 30 a complete outer housing. When the first outer housing 20 and the second outer housing 30 are connected together, the lower end face 261 abuts the upper end face of the barrel portion 31 and the cable 15 passes through the lower end face 261 of the first outer housing 20 and the barrel portion 31. Preferably, the first outer housing is transparent and made of insulating material, e.g., PBT-I-GF30. The second outer housing 30 is made of opaque insulating material which has light absorption property. The second outer housing 30 absorbs the energy of the laser to fuse and weld the first outer housing and the second outer housing together, in a process called laser welding or fusion welding. Referring to FIGS. 3-4 a laser shown as double arrows is aimed at the first outer housing 20 and goes through the first outer housing 20 to the second outer housing 30 as the first outer housing 20 is transparent while the second outer housing is not. The second outer housing 30 generates high temperature when it absorbs the energy of the laser, and then, the first outer housing 20 and the second outer housing 30 melt under the high temperature and are fixed together when they cool down. Preferably, a width of the laser is approximately 0.5 mm.

The base portion 22 has a receiving cavity 221 penetrating both the lower end face 261 and the rear end face 262, a first annular rib 271 extending downwardly from the lower end face 261 and a second annular rib 272 extending backwardly from the rear end face 262. The wire cable component 10 is received in the receiving cavity 221, the rear cover 32 is received in a first receiving groove formed by the second annular rib 272 and an upper portion of the barrel portion 31 is received in a second groove formed by the first annular rib 271 and thus the second outer housing 30 is received and initially restricted in a common receiving groove formed by the first annular rib 271 and the second annular rib 272. Combining with FIGS. 3-4, the laser passes through the first annular rib 271 and the second annular rib 272 respectively and is absorbed by the second outer housing when the laser aims at the first annular rib 271 and the second annular rib 272, and thus an outer face of the second outer housing 30 and an inner face of the first outer housing 20 are welded together when the second outer housing 30 melt under the high temperature generated by the laser. A front face of the rear cover 32 abuts the rear end face 262 of the first housing 20. An abutting portion 321 extending forward from an inner face of the rear cover 32 abuts the wire cable component 10.

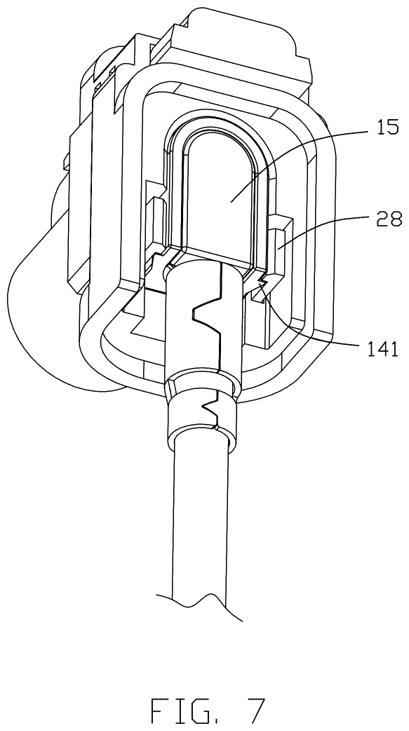

Referring to FIGS. 6-7, the base portion 22 has a pair of locking arms 28 located at two sides of the receiving cavity 221 and extending backward. The wire cable component 10 has a pair of locking blocks 141 latched by the two corresponding locking arms 28 respectively. The wire cable component 10 is assembled into the receiving cavity 221 in a rear to front direction, and meanwhile, the locking blocks 141 climb over hooks of the locking arms 28 and then are latched by the hooks of the locking arms 28, as shown clearly in FIG. 7.

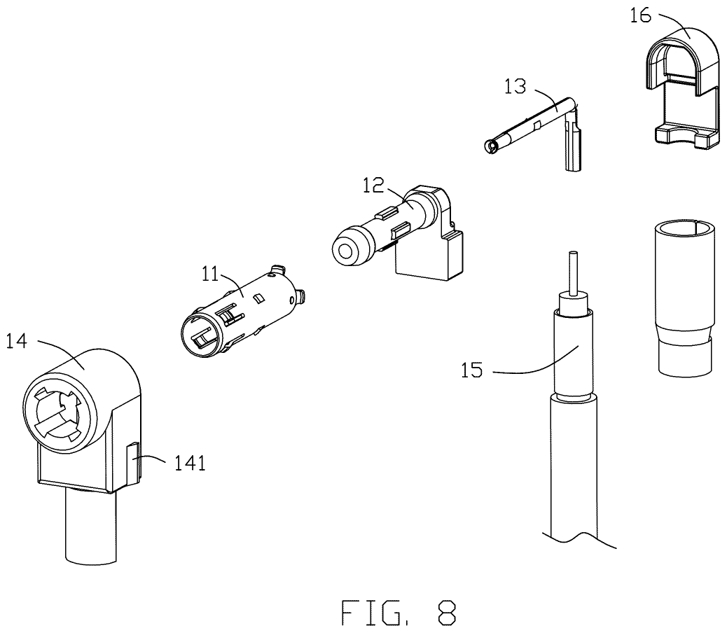

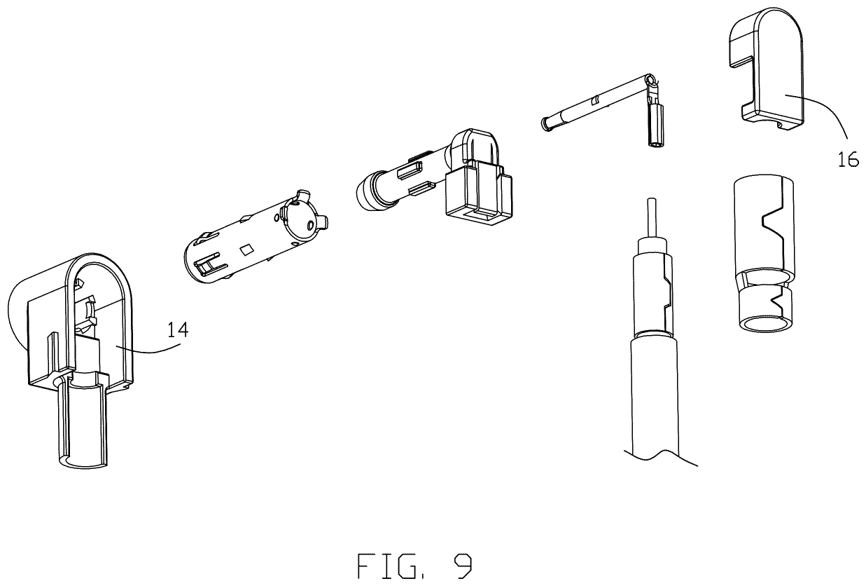

Referring to FIGS. 8-9, the wire cable component 10 comprises the tubular outer conductor 11, the inner insulating housing 12, the inner conductor 13, an L-shaped bending shell 14, the cable 15 and a rear shell 16. The L-shaped bending shell 14 and the rear shell 16 are made by die-casting of aluminum alloy or zinc alloy. The locking blocks 141 are at two sides of the L-shaped bending shell 14.

Although the present invention has been described with reference to particular embodiments, it is not to be construed as being limited thereto. Various alterations and modifications can be made to the embodiments without in any way departing from the scope or spirit of the present invention as defined in the appended claims.

1. An angled cable connector comprising:
a wire cable component comprising an inner conductor, an outer conductor, and a cable electrically connected to the inner conductor;
a first outer housing; and
a second outer housing; wherein
the inner conductor and the outer conductor constitute a mating portion extending forward and the cable extends downward from a rear end of the mating portion;
the first outer housing sleeves the mating portion and the second outer housing sleeves the cable, and the first outer housing and the second outer housing cooperate with each other to form a complete outer housing;
the first outer housing has a lower end face facing downward and a rear end face facing rearward and angled relative to the lower end face, the second outer housing comprises a hollow barrel portion and a rear cover extending upward from a rear part of the barrel portion, and an upper end face of the barrel portion upwardly abuts the lower end face of the first outer housing and a front face of the rear cover forwardly abuts the rear end face of the first outer housing; and
the cable passes downward through the lower end face of the first outer housing and the barrel portion.

2. The angled cable connector as claimed in claim 1, wherein the first outer housing is made of a transparent insulating material, and the second outer housing is made of an opaque insulating material.

3. The angled cable connector as claimed in claim 2, wherein the first outer housing and the second outer housing are fixed by laser welding.

4. The angled cable connector as claimed in claim 1, wherein the lower end face and the rear end face of the first outer housing are perpendicular to each other, and the cable extends downward perpendicular to the lower end face of the first housing.

5. The angled cable connector as claimed in claim 1, wherein the first outer housing comprises a base portion and a tubular mating portion extending forward from the base portion, the base portion has a receiving cavity penetrating both the rear end face and the lower end face and communicating with the tubular mating portion, and the wire cable component is received and retained in the receiving cavity and the tubular mating portion.

6. The angled cable connector as claimed in claim 5, wherein a first annular rib extends downward from the lower end face of the base portion and a second annular rib extends backward from the rear end face of the base portion, and the first annular rib hugs an upper end of the barrel portion and the second annular rib hugs a front end of the rear cover and.

7. The angled cable connector as claimed in claim 6, wherein an inner face of the first annular rib and an inner face of the second annular rib are laser welded to two corresponding parts of the second outer housing respectively.

8. The angled cable connector as claimed in claim 5, wherein the base portion has a pair of locking arms extending backward and located at two sides thereof, and the wire cable component has a pair of locking blocks latched by corresponding locking arms.

9. The angled cable connector as claimed in claim 8, wherein the locking arms are located inwardly of the rear end face of the first housing.

10. The angled cable connector as claimed in claim 1, wherein the wire cable component further comprises an inner insulating housing, an L-shaped bending shell, and a rear shell, the outer conductor extends through the L-shaped bending shell and is fixed in the L-shaped bending shell by a rear end thereof, the inner conductor is received and retained in the inner insulating housing, the inner insulating housing is inserted into the outer conductor from the rear to front direction, and the rear cover covers the inner conductor and the cable.

11. The angled cable connector as claimed in claim 10, wherein the L-shaped bending shell and the rear shell are made by die-casting of aluminum alloy or zinc alloy.

12. The angled cable connector as claimed in claim 11, wherein the L-shaped bending shell has two locking blocks at two sides thereof respectively, the first outer housing has a pair of locking arms extending backward, and the locking blocks are latched by corresponding locking arms respectively.

13. An angled cable connector comprising:
a wire cable component comprising an inner conductor, an outer conductor, and a cable electrically connected with the inner conductor;
a first outer housing; and
a second outer housing; wherein
the first outer housing and the second outer housing cooperate with each other and form a complete outer housing to receive the wire cable component;
the first outer housing has a lower end face facing downward and a rear end face facing rearward, and the second outer housing comprises a hollow barrel portion through which the cable passes and a rear cover extending upward from a rear part of the barrel portion, the barrel portion upwardly abutting the lower end face of the first outer housing and the rear cover forwardly abutting the rear end face of the first outer housing in a front and rear direction; and
a mating edge of the first outer housing and the second outer housing is L-shaped.

14. The angled cable connector as claimed in claim 13, wherein the lower end face and the rear end face of the first outer housing are perpendicular to each other.

15. The angled cable connector as claimed in claim 13, wherein the first housing has a base portion having the lower end face and the rear end face, a tubular mating portion extending forward from the base portion, the base portion has two locking arms at two sides thereof and the wire cable component has two locking blocks latched by corresponding locking arms.

16. The angled cable connector as claimed in claim 15, wherein the base portion has a first annular rib extending downward from the lower end face and a second annular rib extending backward from the rear end face, the rear cover is received in a receiving groove formed by the second annular rib, and an upper end of the barrel portion is received in a receiving groove formed by the first annular rib.

17. The angled cable connector as claimed in claim 16, wherein the first outer housing is made of transparent insulating housing, the second outer housing is made of opaque insulating housing, and the first outer housing and the second outer housing are fixed by laser welding.

18. An angled cable connector comprising:
an L-shaped wire cable component comprising an inner conductor and an outer conductor both extending horizontally forward and a cable electrically connected to and extending downward from a rear end of the inner conductor;
a first outer housing; and
a second outer housing; wherein
the first outer housing has a base portion having a lower opening end face and a rear opening end face angled relative to the lower opening end face, and a tubular mating portion extending horizontally forward from the base portion;
the second outer housing comprises a hollow barrel portion and a rear cover extending upward from a rear part of the barrel portion, an upper end face of the barrel portion upwardly abutting the lower end face of the first outer housing and a front face of the rear cover forwardly abutting the rear end face of the first outer housing; and
the first outer housing and the second outer housing cooperate with each other and form a complete L-shaped outer housing to receive and retain the wire cable component.

19. The angled cable connector as claimed in claim 18, wherein the base portion has a first annular rib extending backward from the rear opening end face and a second annular rib extending downward from the lower opening end face, and the first annular rib hugs a front end of the rear cover and the second annular rib hugs an upper end of the barrel portion.

20. The angled cable connector as claimed in claim 19, wherein the first outer housing and the second outer housing are fixed together by laser welding the first annular rib and the second annular rib.
